(19) United States
(12) Patent Application Publication
(10) Pub. No.: US 2005/0129007 A1
(43) Pub. Date: Jun. 16, 2005

(54) Dual context audio parser

(76) Inventors: Mallinath Hatti, Bangalore (IN); Bhaskar Sherigar, Bangalore (IN)

Correspondence Address: MCANDREWS HELD & MALLOY, LTD, 500 WEST MADISON STREET, SUITE 3400, CHICAGO, IL, 60661, US

(21) Appl. No.: 10/737,492

(22) Filed: Dec. 16, 2003

(51) Int. Cl. H04L 12/28

(52) U.S. Cl. 370/389

(57) ABSTRACT

Presented herein is a dual context audio parser. A header of the audio frame is provided for parsing, the header forming a portion of a particular packet. A first portion of the audio frame is provided for parsing, the first portion of the audio frames being stored in a memory. A second portion of the audio frame is provided for parsing, the second portion of the audio frame forming another portion of the particular packet, after the first portion is parsed.

### RELATED APPLICATIONS

[Not Applicable]

### FEDERALLY SPONSORED RESEARCH OR DEVELOPMENT

[Not Applicable]

### [MICROFICHE/COPYRIGHT REFERENCE]

[Not Applicable]

### BACKGROUND OF THE INVENTION

The audio frames include a frame header and frame data. Pursuant to MPEG-1 Layer 3 (MP3), the packets are of fixed length. The packets are associated with, and carry at least a portion of, an audio frame. However, where the audio frame associated with a packet comprises less data than the length of the packet, the data from the next audio frame is packed into the packet to match the packet length.

When a receiver receives packets, the receiver parses the audio frames. Parsing the audio frames includes parsing the audio frame header followed by the audio frame data. The audio frame header includes information used to parse the audio frame data. However, in cases where a portion of the audio frame data is packed into a previous packet, the portion is encountered before the audio frame header.

Further limitations and disadvantages of conventional and traditional approaches will become apparent to one of ordinary skill in the art through comparison of such systems with the present invention as set forth in the remainder of the present application with reference to the drawings.

### BRIEF SUMMARY OF THE INVENTION

Presented herein is a dual context audio parser.

In one embodiment, there is presented a method for parsing an audio frame. The method comprises providing a header of the audio frame for parsing, the header forming a portion of a particular packet, providing a first portion of the audio frame for parsing, the first portion of the audio frames being stored in a memory, and providing a second portion of the audio frame for parsing, the second portion of the audio frame forming another portion of the particular packet, after parsing the first portion.

In another embodiment, the second portion immediately follows the header in the particular audio frame.

In another embodiment, the first portion of the audio frame forms a portion of another packet, the another packet being received immediately before the particular packet.

In another embodiment, the method further comprises storing a first portion of another audio frame.

In another embodiment, the first portion of the another audio frame immediately follows the second portion of the particular audio frame.

In another embodiment, storing the first portion of the another audio frame further comprises storing the portion of the another audio frame in a first memory, and the method further comprises storing the second portion in a second memory.

In another embodiment, the method further comprises storing the header of the audio frame in the second memory.

In another embodiment, there is presented a system for parsing an audio frame. The system comprises host feed logic, a main FIFO, and a reservoir FIFO. The host feed logic receives a packet. The main FIFO stores an audio frame header and at least a portion of audio frame data associated with the audio frame header, from the packet. The reservoir FIFO stores a portion of audio frame data from another audio frame, from the packet.

In another embodiment, the at least the portion of audio frame data associated with the audio frame header immediately follows the audio frame header in the packet.

In another embodiment, the portion of audio frame data from another audio frame immediately follows the at least the portion of audio frame data associated with the audio frame header.

In another embodiment, an audio frame header for the current audio frame and another portion of audio frame data from future audio frame form a portion of another packet.

In another embodiment, the system further comprises a circuit for fetching the header of the current audio frame from the main FIFO, fetching the portion of the future audio frame from the reservoir FIFO, and fetching the another portion of the another audio frame from the main FIFO after fetching the portion of the another audio frame from the reservoir FIFO.

These and other features and advantages of the present invention may be appreciated from a review of the following detailed description of the present invention, along with the accompanying figures in which like reference numerals refer to like parts throughout.

### BRIEF DESCRIPTION OF SEVERAL VIEWS OF THE DRAWINGS

FIG. 1 is a block diagram describing packets carrying audio frames;

FIG. 2 is a flow diagram for parsing audio frames in accordance with an embodiment of the present invention;

FIG. 3 is a block diagram of a receiver in accordance with an embodiment of the present invention;

FIG. 4 is a flow diagram describing the operation of the host feed logic in accordance with an embodiment of the present invention; and

FIG. 5 is a flow diagram describing the operation of the extractor state machine in accordance with an embodiment of the present invention.

### DETAILED DESCRIPTION OF THE INVENTION

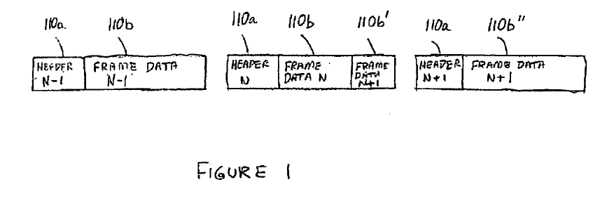

Referring now to FIG. 1, there is illustrated a block diagram of packets 105 carrying audio frames 110. The audio frames 110 include a frame header 110a and frame data. Pursuant to MPEG-1 Layer 3 (MP3), the packets 105 are of fixed length. The packets 105 are associated with, and carry at least a portion of, an audio frame 110. However, where the audio frame 110 associated with a packet 105 comprises less data than the length of the packet 105, the data from the next audio frame 110 is packed into the packet 105 to match the packet length.

For example, packet 105(n−1) is associated with audio frame 110(n−1), and packet 105(n) is associated with audio frame 110(n). Accordingly, packet 105(n−1) carries audio frame header 110a(n−1) and audio frame data 110b(n−1), while packet 105(n) carries audio frame header 110a(n) and audio frame data 110b(n). However, the audio frame 110(n) comprises less data than the length of the packet 105(n). A portion 110b′(n+1) from the audio frame data 110b(n+1) is packed into packet 105(n). The audio frame header 110a(n+1) and the remaining portion 110b″(n+1) of the audio frame data 110b(n+1) are carried in packet 105(n+1).

When a receiver receives packets 105, the receiver parses the audio frames 110. Parsing the audio frames 110 includes parsing the audio frame header 110a followed by the audio frame data 110b. The audio frame header 110a includes information used to parse the audio frame data 110b. However, in cases where a portion of the audio frame data 110b′ is packed into a previous packet 105, the portion 110b′ is encountered before the audio frame header 110a. For example, audio frame data portion 110b′(n+1) is encountered before the audio frame header 110a(n+1). In order to parse audio frame data portion 110b′(n+1), the audio fame data portion 110b′(n+1) is stored until the audio frame header 110a(n+1) is parsed. After parsing audio frame header 110a(n+1), the audio frame data portion 110b′(n+1) is retrieved from storage and parsed. After the portion of the audio frame data 110b′(n+1) is parsed, the remaining portion of the audio frame data 110b″(n+1) is parsed.

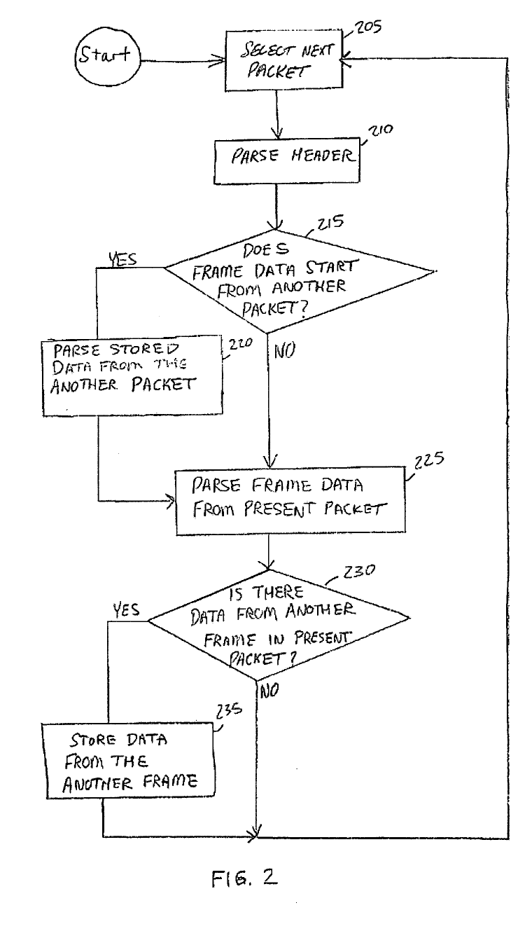

Referring now to FIG. 2, there is illustrated a block diagram for parsing audio frames. At 205, a particular packet is selected. At 210, the audio frame header 110a is parsed. If a portion 110b′ of the audio frame data 110b is carried in another packet 105 at 215, such as the previous packet, the portion of the audio frame data 110b′ stored in the another packet 105 is parsed at 220. If at 215, there is no portion of the audio frame data 110b′ carried in another packet 105, 220 is bypassed.

At 225, the audio frame data 110b carried in the packet 105 is parsed. At 230, a determination is made whether a portion of another audio frame data 110b′ is stored in the packet 105. If a portion of another audio frame data 100b′ is stored in the packet 105, the portion of another audio frame data 110b′ is stored at 235. Otherwise, 235 is bypassed. The foregoing, 205-235, is then repeated for the next packet 105.

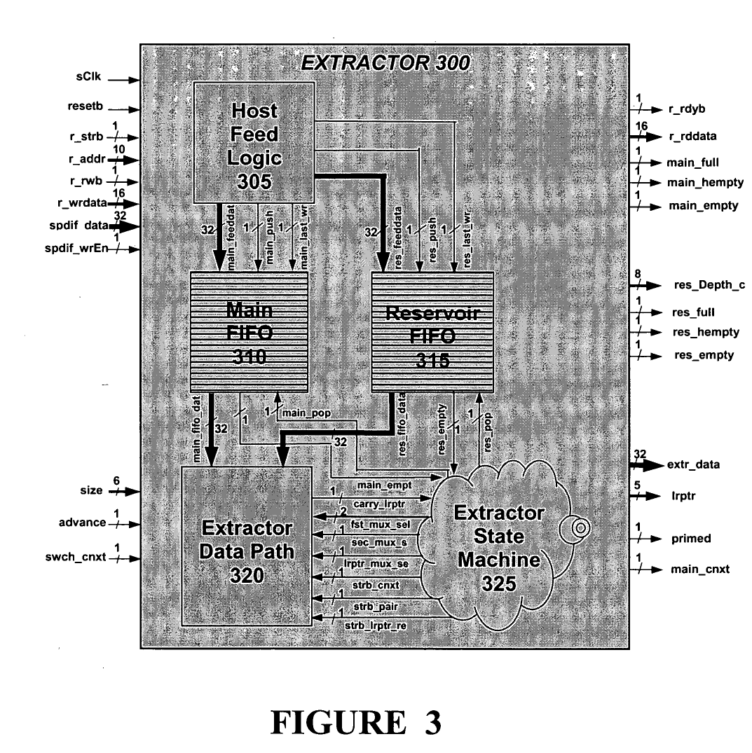

Referring now to FIG. 3, there is illustrated a block diagram of a receiver 300 for parsing audio frames in accordance with an embodiment of the present invention. The receiver 300 comprises host feed logic 305, a main FIFO 310, a reservoir FIFO 315, an extractor data path 320, and an extractor state machine 325.

The host feed logic 305 receives packets 105. When the host feed logic 305 receives a packet 105, the host feed logic 305 places the audio frame header 110a and the audio frame data 110b of the data audio frame 110 associated with the packet into the main FIFO 310.

However, where the audio frame 110 comprises less data than the length of the packet 105, a portion of the next audio frame data 110b′ is carried in the packet 105 to fill the length of the packet. Where the packet 105 includes a portion of the next audio frame data 110b′, the host feed logic 305 writes the portion of the next audio frame data 110b′ in the reservoir FIFO 315.

For example, packet 105(n) carries audio frame header 110a(n), audio frame data 110b(n), and a portion of audio frame data 110b′(n+1). When the host feed logic 305 receives packet 105(n), the host feed logic 305 writes the audio frame header 110a(n) and the audio frame data 110b(n) in the main FIFO 310. The host feed logic 305 writes the audio frame data 110b′(n+1) into the reservoir FIFO 315.

The extractor data path 320 provides the audio frames 110 for parsing. The extractor state machine 325 controls the extractor data path 320. The extractor state machine 325 causes the extractor data path 320 to fetch and output audio frame headers 110a followed by audio frame data 110b.

As noted above, some audio frames 110 may include audio frame data 110b that is stored in both the main FIFO 310 and the reservoir FIFO 315. For example, the portion of audio frame data 110b′(n+1) gets stored in the reservoir FIFO 315, while the audio frame header 110a(n+1) and the portion of audio frame data 110b″(n+1) get stored in the main FIFO 310.

When the extractor data path 320 provides the audio frame header 110a(n+1) for parsing, the extractor state machine 325 detects that the audio frame data portion 110b′(n+1) is not stored in the main FIFO 315. Upon detecting that the audio frame data portion 110b′(n+1) is not stored in the main FIFO 315, the extractor state machine 325 causes the extractor data path 320 to fetch and provide the audio frame data portion 110b′(n+1) from the reservoir FIFO 310 for parsing. When the extractor data path 320 finishes fetching and providing audio frame data portion 110 for parsing, the extractor state machine 325 detects the foregoing and causes the extractor data path 110 to fetch and provide the remaining portion of the audio frame data 110b″(n+1) from the reservoir FIFO 310 for parsing.

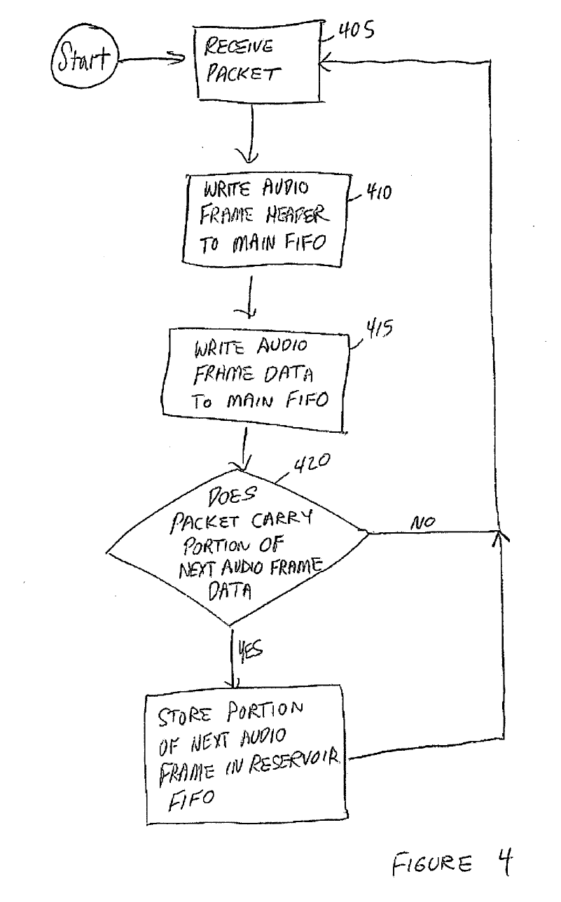

Referring now to FIG. 4, there is illustrated a flow diagram describing the operation of the host feed logic 305 in accordance with an embodiment of the present invention. At 405, a particular packet 105 is received. At 410, the audio frame header 110a of the audio frame 110 associated with the packet 105 received during 405 is written to the main FIFO 310. At 415, the audio frame data 110b of the audio frame 110 associated with the packet 105 is written to the main FIFO 310.

As noted above, if an audio frame 110 comprises less data than the packet 105 associated therewith, a portion of the audio frame data 110b′ from the next audio frame is also carried in the packet 105. Accordingly, at 420, a determination is made whether the packet 105 carries a portion of the next audio frame data 110b′.

If during 420, the packet 105 does carry a portion of the next audio frame data 110b, the portion of the next audio frame data 110b′ is written (425) to the reservoir FIFO. If the packet 105 does not carry a portion of the next audio frame data 110b, 425 is bypassed. The host feeder logic 305 then repeats 405 for the next packet.

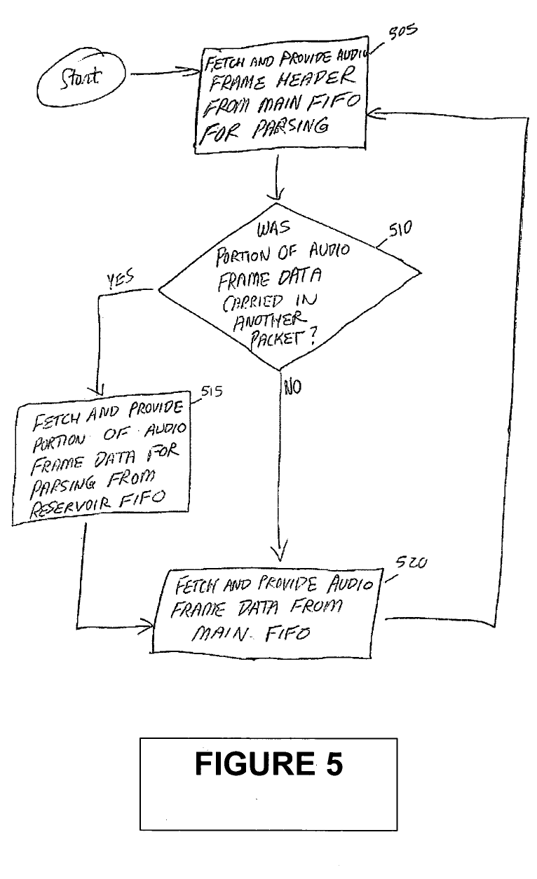

Referring now to FIG. 5, there is illustrated a block diagram describing the operation of the extractor data path 320 and the extractor state machine 325 in accordance with an embodiment of the present invention. At 505, the extractor state machine 325 provides the audio frame header 110a from the main FIFO 310 for parsing. At 510, a determination is made whether a portion of the audio frame data 110b′ was carried in a different packet 105 from the packet 105 carrying the audio frame header 110a.

As noted above, if the previous audio frame 110 comprises less data than the packet 105 length associated therewith, a portion of the audio frame data 110b′ is also carried in the packet 105. In the foregoing case, the host feed logic 320 writes the portion of the audio frame data 110b′ to the reservoir FIFO 315.

If at 510, a portion of the audio frame data 110b′ was carried in a different packet 105, the extractor data path 320 fetches and provides (515) the portion of the audio frame data 110b′ from the reservoir FIFO 315 for parsing. If at 510, no portion of the audio frame data 110b′ was carried in a different packet, 515 is bypassed. At 520, the extractor data path 320 fetches either the remaining portion of the audio frame data 110b″ or the entire audio frame data lob from the main FIFO 315.

The embodiments described herein may be implemented as a board level product, as a single chip, application specific integrated circuit (ASIC), or with varying levels of the decoder system integrated with other portions of the system as separate components. The degree of integration of the decoder system will primarily be determined by the speed and cost considerations. Because of the sophisticated nature of modern processor, it is possible to utilize a commercially available processor, which may be implemented external to an ASIC implementation. Alternatively, if the processor is available as an ASIC core or logic block, then the commercially available processor can be implemented as part of an ASIC device wherein certain functions can be implemented in firmware.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

1. A method for parsing an audio frame, said method comprising:
providing a header of the audio frame for parsing, the header forming a portion of a particular packet;
providing a first portion of the audio frame for parsing, the first portion of the audio frame being stored in a memory; and
providing a second potion of the audio frame for parsing, the second portion of the audio frame forming another portion of the particular packet, after parsing the first portion.

2. The method of claim 1, wherein the second portion immediately follows the header in the particular audio frame.

3. The method of claim 1, wherein the first portion of the audio frame forms a portion of another packet, the another packet being received immediately before the particular packet.

4. The method of claim 1, further comprising:
storing a first portion of another audio frame.

5. The method of claim 4, wherein the first portion of the another audio frame immediately follows the second portion of the particular audio frame.

6. The method of claim 4, wherein storing the first portion of the another audio frame further comprises storing the portion of the another audio frame in a first memory, and wherein the method further comprises:
storing the second portion in a second memory.

7. The method of claim 6, further comprising:
storing the header of the audio frame in the second memory.

8. A system for parsing an audio frame, said system comprising:
host feed logic for receiving a packet;
a main FIFO for storing an audio frame header and at least a portion of audio frame data associated with the audio frame header, from the packet; and
a reservoir FIFO for storing a portion of audio frame data from another audio frame, from the packet.

9. The system of claim 8, wherein the at least the portion of audio frame data associated with the audio frame header immediately follows the audio frame header in the packet.

10. The system of claim 8, wherein the portion of audio frame data from another audio frame immediately follows the at least the portion of audio frame data associated with the audio frame header.

11. The system of claim 8, wherein an audio frame header for the another audio frame and another portion of audio frame data from another audio frame form a portion of another packet.

12. The system of claim 11, further comprising a circuit for:
fetching the header of the audio frame for the another audio frame from the main FIFO;
fetching the portion of the another audio frame from the reservoir FIFO; and
fetching the another portion of the another audio frame from the main FIFO after fetching the portion of the another audio frame from the reservoir FIFO.
